(19) United States
(12) Patent Application Publication
(10) Pub. No.: US 2024/0236945 A1
(43) Pub. Date: Jul. 11, 2024

(54) METHOD AND APPARATUS FOR STATE TRANSITION IN WIRELESS COMMUNICATION SYSTEM

(71) Applicant: LG ELECTRONICS INC., Seoul (KR)

(72) Inventors: Hongsuk KIM, Seoul (KR); Sunghoon JUNG, Seoul (KR)

(73) Assignee: LG ELECTRONICS INC., Seoul (KR)

(21) Appl. No.: 18/562,010

(22) PCT Filed: May 25, 2022
(86) PCT No.: PCT/KR2022/007437

§ 371 Date: Nov. 17, 2023

(30) Foreign Application Priority Data
May 25, 2021 (KR) 10-2021-0067124

(51) Int. Cl. H04W 68/02; H04W 60/04; H04W 76/10; H04W 76/20; H04W 76/30

(52) U.S. Cl. CPC H04W 68/02; H04W 60/04; H04W 76/10; H04W 76/20; H04W 76/30

(57) ABSTRACT

The present disclosure related to a state transition in wireless communications. According to an embodiment of the present disclosure, a user equipment (UE) transmits, to a first network, an indication that paging filtering information is to be transmitted together with radio resource control (RRC) state preference for leaving a connected state in the first network. Therefore, RRC release message for leaving the connected state can be received after the paging filtering information is transmitted.

### CROSS-REFERENCE TO RELATED APPLICATION(S)

This application is the National Stage filing under 35 U.S.C. 371 of International Application No. PCT/KR2022/007437, filed on May 25, 2022, which claims the benefit of earlier filing date and right of priority to Korean Application No. 10-2021-0067124, filed on May 25, 2021, the contents of which are all incorporated by reference herein in their entirety.

### TECHNICAL FIELD

The present disclosure related to a state transition in wireless communications.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In wireless communications, a user equipment (UE) may perform a state transition from the current state to another state. The state may comprise a connected state in which a connection is established with the UE and a network, an inactive state in which the connection is suspended, or an idle state in which the connection is released. The UE may perform the state transmission due to various reasons.

For example, in a multi-user subscriber identity module (MUSIM) operation associated with a first network and a second network, the UE may receive a paging from the second network while in a connected mode for the first network. In this case, the UE may leave the connected mode for the first network, establish a connection with the second network, and receive incoming services related to the paging from the second network.

### SUMMARY

An aspect of the present disclosure is to provide method and apparatus for state transmission in a wireless communication system.

Another aspect of the present disclosure is to provide method and apparatus for state transmission for MUSIM operation in a wireless communication system.

According to an embodiment of the present disclosure, a method performed by a user equipment (UE) in a wireless communication system comprises: registering to a first network and a second network: establishing a connection with the first network: receiving, from the second network, a paging for a switching operation from the first network to the second network: transmitting, to the first network, first information informing a state of the connection preferred by the UE and second information informing that paging filtering information is to be transmitted: transmitting, to the first network, the paging filtering information informing one or more types of paging preferred by the UE: and receiving, from the first network based on the second information, a message instructing to leave a connected state in the first network after transmitting the paging filtering information.

According to an embodiment of the present disclosure, a user equipment (UE) configured to operate in a wireless communication system comprises: at least one transceiver; at least processor: and at least one computer memory operably connectable to the at least one processor and storing instructions that, based on being executed by the at least one processor, perform operations comprising: registering to a first network and a second network; establishing a connection with the first network; receiving, from the second network, a paging for a switching operation from the first network to the second network; transmitting, to the first network, first information informing a state of the connection preferred by the UE and second information informing that paging filtering information is to be transmitted; transmitting, to the first network, the paging filtering information informing one or more types of paging preferred by the UE: and receiving, from the first network based on the second information, a message instructing to leave a connected state in the first network after transmitting the paging filtering information.

According to an embodiment of the present disclosure, at least one computer readable medium (CRM) stores instructions that, based on being executed by at least one processor, perform operations comprising: registering to a first network and a second network; establishing a connection with the first network; receiving, from the second network, a paging for a switching operation from the first network to the second network; transmitting, to the first network, first information informing a state of the connection preferred by the UE and second information informing that paging filtering information is to be transmitted: transmitting, to the first network, the paging filtering information informing one or more types of paging preferred by the UE; and receiving, from the first network based on the second information, a message instructing to leave a connected state in the first network after transmitting the paging filtering information.

According to an embodiment of the present disclosure, an apparatus for configured to operate in a wireless communication system comprises: at least processor; and at least one computer memory operably connectable to the at least one processor, wherein the at least one processor is configured to perform operations comprising: registering to a first network and a second network: establishing a connection with the first network: receiving, from the second network, a paging for a switching operation from the first network to the second network; transmitting, to the first network, first information informing a state of the connection preferred by the UE and second information informing that paging filtering information is to be transmitted: transmitting, to the first network, the paging filtering information informing one or more types of paging preferred by the UE; and receiving, from the first network based on the second information, a message instructing to leave a connected state in the first network after transmitting the paging filtering information.

According to an embodiment of the present disclosure, a method performed by a network node configured to operate in a wireless communication system comprises: registering a user equipment (UE) in a first network: establishing a connection with the UE; receiving, from the UE after the UE is paged by a second network, i) first information informing an intend of the UE to leave a connected state in the first network and a state in the first network preferred by the UE after the leaving, and ii) second information informing that paging filtering information is to be transmitted: delaying a transmission of a message instructing to leave a connected state in the first network to the UE until the paging filtering information is received from the UE, based on the second information: receiving, from the UE, the paging filtering information informing one or more types of paging preferred by the UE: and transmitting, to the UE, the message instructing to leave a connected state in the first network after receiving the paging filtering information.

According to an embodiment of the present disclosure, a network node configured to operate in a wireless communication system comprises: at least one transceiver; at least processor; and at least one computer memory operably connectable to the at least one processor and storing instructions that, based on being executed by the at least one processor, perform operations comprising: registering a user equipment (UE) in a first network: establishing a connection with the UE; receiving, from the UE after the UE is paged by a second network, i) first information informing an intend of the UE to leave a connected state in the first network and a state in the first network preferred by the UE after the leaving, and ii) second information informing that paging filtering information is to be transmitted: delaying a transmission of a message instructing to leave a connected state in the first network to the UE until the paging filtering information is received from the UE, based on the second information; receiving, from the UE, the paging filtering information informing one or more types of paging preferred by the UE; and transmitting, to the UE, the message instructing to leave a connected state in the first network after receiving the paging filtering information.

The present disclosure can have various advantageous effects.

For example, the UE can send the RRC state preference for entering RRC_INACTIVE and MT restriction for paging filtering. As the result, the network can transfer the UE into RRC_INACTIVE state and can send the filtered paging messages to the UE in RRC_INACTIVE. Upon reception of the filtered paging message, the UE can perform an RRC connection resume procedure which can achieve faster data transmission than RRC connection establishment.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of possible RRC states in a wireless communication system to which technical features of the present disclosure can be applied.

FIG. 11 shows an example of a wireless environment in which a MUSIM device operates according to an embodiment of the present disclosure.

FIG. 12 shows an example of a paging filtering based paging delivery in CM-IDLE state in 5GS according to an embodiment of the present disclosure.

FIG. 13 shows an example of a prioritized service list based paging delivery in RRC-inactive state in 5GS according to an embodiment of the present disclosure.

FIG. 14 shows an example of a method performed by a UE according to an embodiment of the present disclosure.

FIG. 15 shows an example of a method performed by a network node according to an embodiment of the present disclosure.

FIG. 16 shows an example of a method for sending RRC preference for MT restriction in MUSIM according to an embodiment of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Throughout the disclosure, the terms ‘radio access network (RAN) node’, ‘base station’, ‘eNB’, ‘gNB’ and ‘cell’ may be used interchangeably. Further, a UE may be a kind of a wireless device, and throughout the disclosure, the terms ‘UE’ and ‘wireless device’ may be used interchangeably.

Throughout the disclosure, the terms ‘cell quality’, ‘signal strength’, ‘signal quality’, ‘channel state’, ‘channel quality’, ‘ channel state/reference signal received power (RSRP)’ and ‘ reference signal received quality (RSRQ)’ may be used interchangeably.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

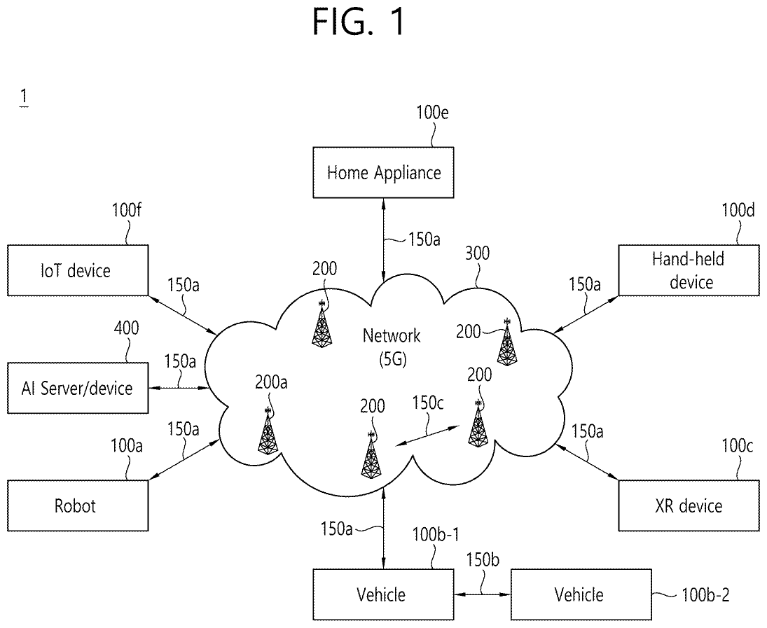

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IOT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

Here, the radio communication technologies implemented in the wireless devices in the present disclosure may include narrowband internet-of-things (NB-IOT) technology for low-power communication as well as LTE, NR and 6G. For example, NB-IOT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

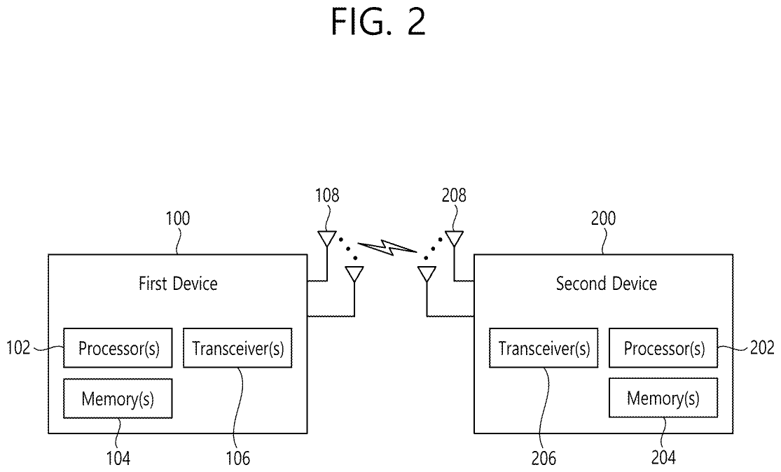

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

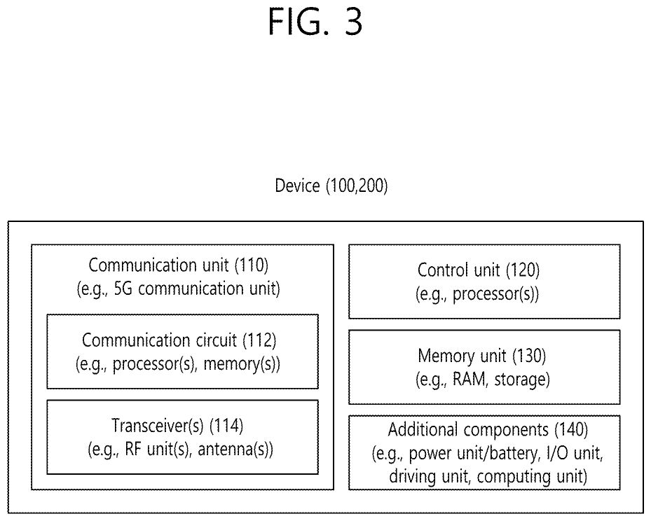

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

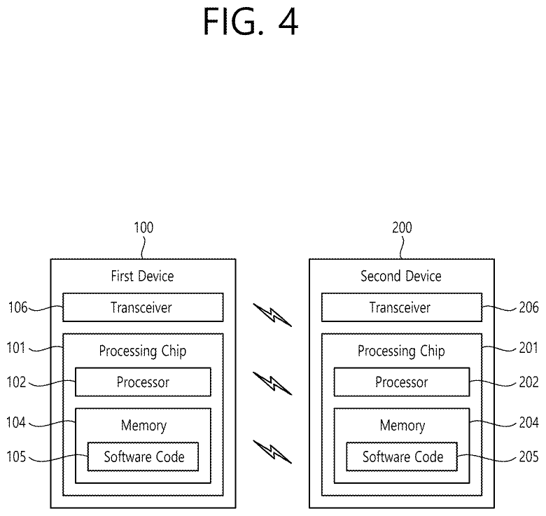

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

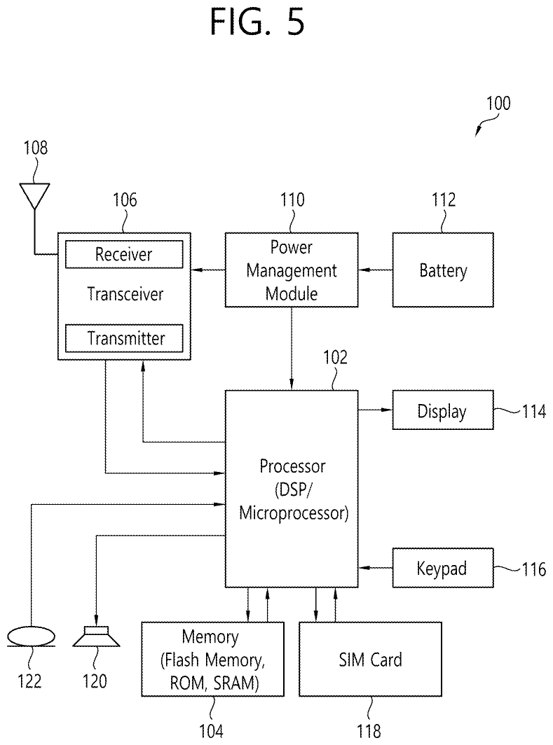

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

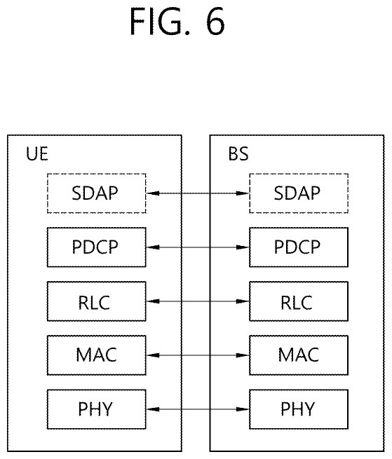

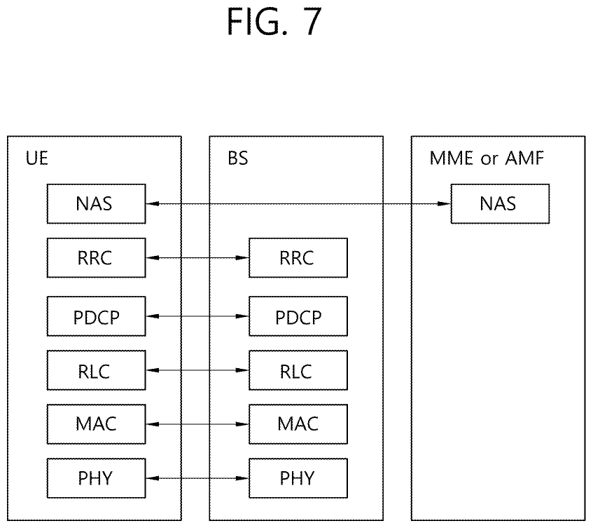

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include; mapping between logical channels and transport channels: multiplexing/de-multiplexing of MAC SDUs belonging to one or different logical channels into/from transport blocks (TB) delivered to/from the physical layer on transport channels: scheduling information reporting; error correction through hybrid automatic repeat request (HARQ) (one HARQ entity per cell in case of carrier aggregation (CA)): priority handling between UEs by means of dynamic scheduling: priority handling between logical channels of one UE by means of logical channel prioritization: padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH): BCCH can be mapped to downlink shared channel (DL-SCH): PCCH can be mapped to paging channel (PCH): CCCH can be mapped to DL-SCH; DCCH can be mapped to DL-SCH: and DTCH can be mapped to DL-SCH. In uplink, the following connections between logical channels and transport channels exist: CCCH can be mapped to uplink shared channel (UL-SCH): DCCH can be mapped to UL-SCH: and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs: sequence numbering independent of the one in PDCP (UM and AM): error correction through ARQ (AM only); segmentation (AM and UM) and re-segmentation (AM only) of RLC SDUs: reassembly of SDU (AM and UM): duplicate detection (AM only): RLC SDU discard (AM and UM): RLC re-establishment: protocol error detection (AM only).

In the 3GPP NR system, the main services and functions of the PDCP sublayer for the user plane include: sequence numbering: header compression and decompression using robust header compression (ROHC): transfer of user data: reordering and duplicate detection: in-order delivery: PDCP PDU routing (in case of split bearers); retransmission of PDCP SDUs; ciphering, deciphering and integrity protection: PDCP SDU discard: PDCP re-establishment and data recovery for RLC AM: PDCP status reporting for RLC AM: duplication of PDCP PDUs and duplicate discard indication to lower layers. The main services and functions of the PDCP sublayer for the control plane include: sequence numbering: ciphering, deciphering and integrity protection: transfer of control plane data: reordering and duplicate detection: in-order delivery: duplication of PDCP PDUs and duplicate discard indication to lower layers.

In the 3GPP NR system, the main services and functions of SDAP include: mapping between a QoS flow and a data radio bearer: marking QoS flow ID (QFI) in both DL and UL packets. A single protocol entity of SDAP is configured for each individual PDU session.

In the 3GPP NR system, the main services and functions of the RRC sublayer include; broadcast of system information related to AS and NAS: paging initiated by 5GC or NG-RAN; establishment, maintenance and release of an RRC connection between the UE and NG-RAN; security functions including key management: establishment, configuration, maintenance and release of signaling radio bearers (SRBs) and data radio bearers (DRBs): mobility functions (including: handover and context transfer, UE cell selection and reselection and control of cell selection and reselection, inter-RAT mobility): QoS management functions: UE measurement reporting and control of the reporting: detection of and recovery from radio link failure: NAS message transfer to/from NAS from/to UE.

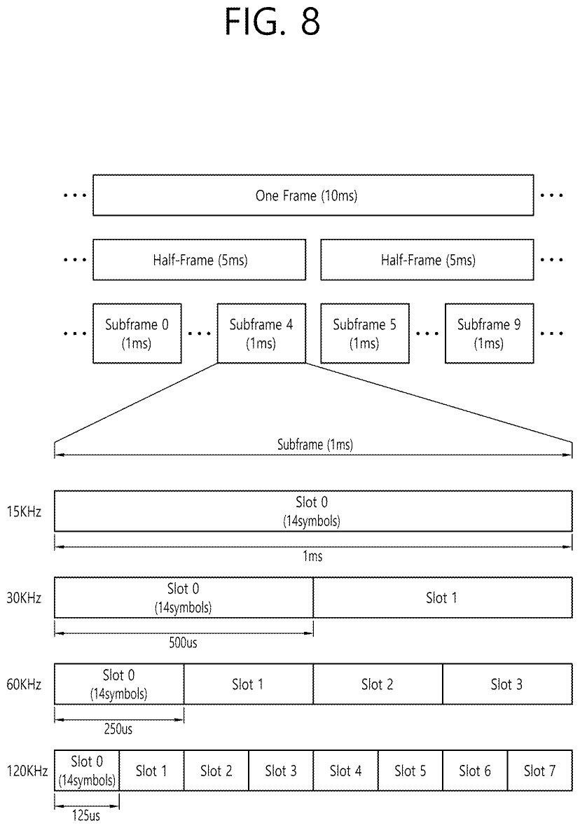

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is Ims. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u*}15 KHz.

Table 1 shows the number of OFDM symbols per slot N_{symb}^{slot}, the number of slots per frame Nₛₗₒₜ^{frame,u}, and the number of slots per subframe Nₛₗₒₜ^{subframe,u} for the normal CP, according to the subcarrier spacing βf=2^{u*}15 KHz.

TABLE 1

| u | N^{slot}_{symb} | N^{frame,u}ₛₗₒₜ | N^{subframe,u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N_{symb}^{slot}, the number of slots per frame Nₛₗₒₜ^{frame,u} and the number of slots per subframe Nₛₗₒₜ^{subframe,u} for the extended CP, according to the subcarrier spacing βf=2^{u*}15 KHz.

TABLE 2

| u | N^{slot}_{symb} | N^{frame,u}ₛₗₒₜ | N^{subframe,u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N_{grid,x}^{size,u}*N_{sc}^{RB} subcarriers and N_{symb}^{subframe,u} OFDM symbols is defined, starting at common resource block (CRB) N_{grid}^{start,u} indicated by higher-layer signaling (e.g., RRC signaling), where N_{grid,x}^{size,u} is the number of resource blocks (RBs) in the resource grid and the subscript x is DL for downlink and UL for uplink. N_{sc}^{RB} is the number of subcarriers per RB. In the 3GPP based wireless communication system, N_{sc}^{RB} is 12 generally. There is one resource grid for a given antenna port p, subcarrier spacing configuration u, and transmission direction (DL or UL). The carrier bandwidth N_{grid}^{size,u} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N_{BWP,i}^{size}-1, where i is the number of the bandwidth part. The relation between the physical resource block n_{PRB} in the bandwidth part i and the common resource block n_{CRB} is as follows: n_{PRB}=n_{CRB}+N_{BWP,i}^{size}, where N_{BWP,i}^{size} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHZ (or 5850, 5900, 5925 MHZ, etc.) or more included in FR1 may include an unlicensed band. Unlicensed bands may be used for a variety of purposes, for example for communication for vehicles (e.g., autonomous driving).

TABLE 4

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times. In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

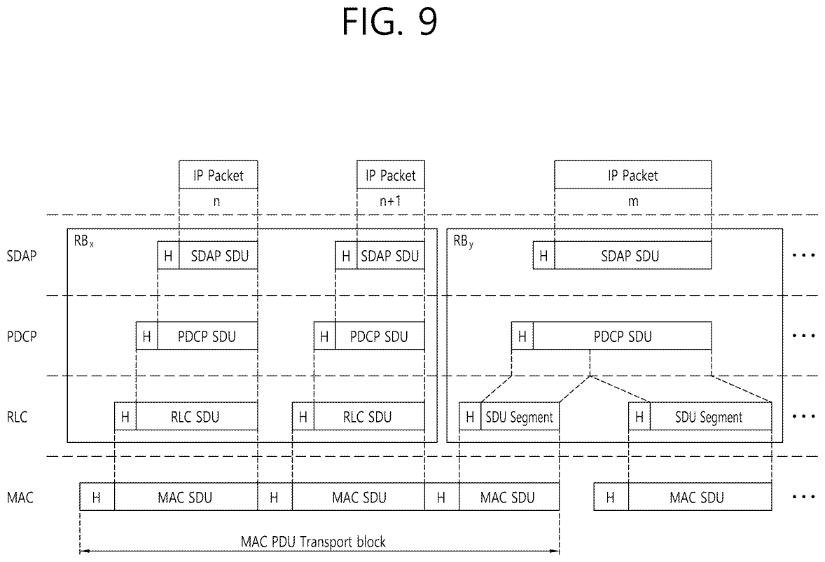

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

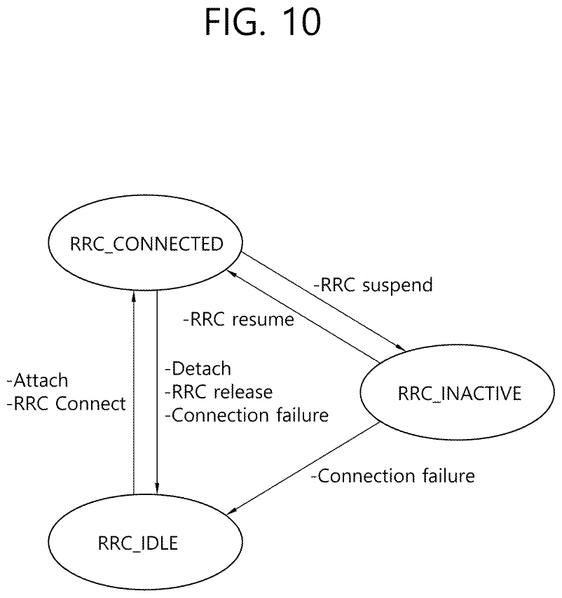

FIG. 10 shows an example of possible RRC states in a wireless communication system to which technical features of the present disclosure can be applied.

Referring to FIG. 10, there may be 3 possible RRC states in a wireless communication system (i.e., RRC_IDLE, RRC_CONNECTED and/or RRC_INACTIVE).

In RRC_IDLE (or, idle mode/state), RRC context for communication between a UE and a network may not be established in RAN, and the UE may not belong to a specific cell. Also, in RRC_IDLE, there is no core network connection for the UE. Since the device remains in sleep mode in most of the time to reduce battery consumption, data transfer between the UE and the network may not occur. UEs in RRC_IDLE may periodically wake-up to receive paging messages from the network. Mobility may be handled by the UE through cell reselection. Since uplink synchronization is not maintained, the UE may not perform uplink transmission other than transmissions for random access (e.g., random access preamble transmission) to move to RRC_CONNECTED.

In RRC_CONNECTED (or, connected state/mode), RRC context for communication between a UE and a network may be established in RAN. Also, in RRC_CONNECTED, core network connection is established for the UE. Since the UE belongs to a specific cell, cell-radio network temporary identifier (C-RNTI) for signalings between the UE and the network may be configured for the UE. Data transfer between the UE and the network may occur. Mobility may be handled by the network—that is, the UE may provide measurement report to the network, and the network may transmit mobility commands to the UE to perform a mobility. Uplink time alignment may need to be established based on a random access and maintained for data transmission.

In RRC_INACTIVE (or, inactive state/mode), RRC context for communication between a UE and a network may be kept in RAN. Data transfer between the UE and the network may not occur. Since core network connection may also be kept for the UE, the UE may fast transit to a connected state for data transfer. In the transition, core network signalling may not be needed. The RRC context may be already established in the network and idle-to-active transitions can be handled in the RAN. The UE may be allowed to sleep in a similar way as in RRC_IDLE, and mobility may be handled through cell reselection without involvement of the network. The RRC_INCATIVE may be construed as a mix of the idle state and the connected state.

As illustrated in FIG. 10, the UE may transit to RRC_CONNECTED from RRC_IDLE by performing initial attach procedure or RRC connection establishment procedure. The UE may transit to RRC_IDLE from RRC_CONNECTED when detach, RRC connection release (e.g., when the UE receives RRC release message) and/or connection failure (e.g., radio link failure (RLF)) has occurred. The UE may transit to RRC_INACTIVE from RRC_CONNECTED when RRC connection is suspended (e.g., when the UE receives RRC release message including a suspend configuration), and transit to RRC_CONNECTED from RRC_INACTIVE when RRC connection is resume by performing RRC connection resume procedure. The UE may transit to RRC_IDLE from RRC_INACTIVE when connection failure such as RLF has occurred.

Hereinafter, contents related to a multi-universal subscriber identity module (MUSIM) is described.

Multi-USIM devices (e.g., MUSIM device 1110) have been more and more popular in different countries. The user may have both a personal and a business subscription in one device or have two personal subscriptions in one device for different services.

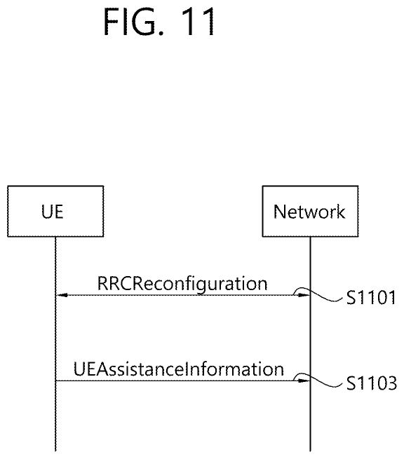

FIG. 11 shows an example of a wireless environment in which a MUSIM device operates according to an embodiment of the present disclosure.

Referring to FIG. 11, MUSIM device 1110 (or, MUSIM UE 1110) may have a plurality of universal subscriber identity modules (USIMs)—USIM1 1111 (or, USIM_A 1111) and USIM2 1113 (USIM_B 1113). The MUSIM device 1110 may register to a network 1 1120 based on subscription information in the USIM1 1111 to obtain a connection A 1125 between the network 1 1120 and the MUSIM device 1110. The MSUIM device 1110 may also register to a network 2 1130 based on subscription information in the USIM2 1113 to obtain a connection B 1135 between the network 2 1130 and the MUSIM device 1110. The MUSIM device 1110 may use the USIM1 1111 to perform a communication with the network 1 1120 over the connection A 1125, and use the USIM2 1113 to perform a communication with the network 2 1130 over the connection B 1135.

In a wireless environment in which a MUSIM device operates, the following properties may hold:
Each registration from the USIMS of a MUSIM device may be handled independently.
Each registered USIM in the MUSIM device may be associated with a dedicated international mobile equipment identity (IMEI)/permanent equipment identifier (PEI).
A MUSIM UE may be connected with i) evolved packet system (EPS) on one USIM_And 5G system (5GS) on the other USIM: ii) EPS on both USIMs; or iii) 5GS on both USIMs.
A MUSIM UE may be a single reception (RX)/dual RX/single transmission (TX)/Dual TX UE. Single RX may allow the MUSIM UE to receive traffic from only one network at one time. Dual RX may allow the MUSIM UE to simultaneously receive traffic from two networks. Single TX may allow the MUSIM UE to transmit traffic to one network at one time. Dual TX may allow the MUSIM UE to simultaneously transmit traffic to two networks. The terms single RX/TX and Dual RX/TX do not refer to a device type. A single UE may, as an example, use Dual TX in some cases but Single TX in other case.
If/when the multiple USIMs in the MUSIM device are served by different serving networks, network coordination between the serving networks may not be required.
A MUSIM device with different USIMs may be camping with all USIMs on the same serving network RAN node, or the MUSIM device may be camping on different serving networks RAN nodes.
USIMs may belong to same or different operators. Coordination between involved operators may not be required.
USIM may be a physical SIM or embedded SIM (eSIM).

While actively communicating with a first system/network, a MUSIM UE may need to periodically monitor a second system/network (e.g. to synchronize, read the paging channel, perform measurements, or read the system information). The periodical activity on the second system may or may not have performance impact on the first system the UE is communicating with, depending on the UE implementation (i.e., single reception (Rx) or dual Rx).

In some cases, the UE equipped with different USIMs may have paging collisions which results in missed paging. When the UE receives a page in the second system while actively communicating with the first system, the UE may need to decide whether the UE should respond to this paging or not. When the UE decides to respond to the paging in the second system, the UE may need to stop the current activity in the first system. For example, the first system may suspend or release the ongoing connection with the UE.

For the multi-USIM UE, if USIM_A is in connected mode and USIM_B is in idle or RRC_INACTIVE mode, then the UE should be able to maintain RRC connection in USIM_A but may also be required to tune to USIM_B periodically to listen to paging. While the UE is absent from the network where USIM_A is camped, if the UE cannot receive DL data, it may result in waste of resources and degrade USIM_A connected mode performance, e.g., the RAN node for USIM_A may determine USIM_A has lost the traffic and reduce the scheduling rate.

The “scheduling gap” on USIM_A may be negotiated for the UE to tune away to USIM_B in order to listen to paging and then return to USIM_A. Since the tune away for listening paging happens periodically, the “scheduling gap” negotiated between the UE and RAN may be applied periodically.

USIM_A (i.e., UE in connected mode for USIM_A) may negotiate the “scheduling gap” with the served RAN node so the UE can tune away from USIM_A to perform the USIM_B procedures. For example, the USIM_A may transmit a request message for requesting a scheduling gap to the served RAN node. The request message may comprise at least one of a scheduling gap preferred by the USIM_A, or capability information of the USIM_A for the served RAN node to determine the scheduling gap. The served RAN node may transmit a response message for the request message to the USIM_A. The response message may comprise a scheduling gap determined by the served RAN node based on information included in the request message. That is, the response message may comprise a configuration related to the scheduling gap.

Hereinafter, UE assistance information procedure is described.

FIG. 11 shows an example of a UE assistance information procedure according to an embodiment of the present disclosure.

Referring to FIG. 11, in step S1101, the UE may receive an RRC reconfiguration message from a network. For MUSIM operation, the RRC reconfiguration message may comprise at least one of musim-GapConfig, musim-GapAssistanceConfig or musim-LeaveAssistanceConfig.

The musim-GapConfig may comprise at least one of the following information elements (IEs) as shown in table 5:

TABLE 5

| | |
|---|---|
| -- ASN1START | |
| -- TAG-MUSIM-GAPCONFIG-START | |
| MUSIM-GapConfig-r17 ::= | SEQUENCE |

| | |
|---|---|
| musim-GapToReleaseList-r17 | SEQUENCE (SIZE (1..2)) OF MUSIM- |

| | |
|---|---|
| GapID-r17 | OPTIONAL, |

| | |
|---|---|
| musim-GapToAddModList-r17 | SEQUENCE (SIZE (1..2)) OF MUSIM- |

| | |
|---|---|
| GapInfo-r17 | OPTIONAL, |

| | |
|---|---|
| musim-AperiodicGap-r17 | MUSIM-GapInfo-r17 |
| OPTIONAL, -- Need N | |
| ... | |
| } | |

| | |
|---|---|
| MUSIM-GapInfo-r17 ::= | SEQUENCE { |

| | |
|---|---|
| musim-GapID-r17 | MUSIM-GapID-r17 |
| OPTIONAL, -- Cond periodic | |
| musim-Starting-SFN-AndSubframe-r17 | MUSIM-Starting-SFN- |

| | |
|---|---|
| AndSubframe-r17 | OPTIONAL, -- Cond aperiodic |

| | |
|---|---|
| musim-GapLength-r17 | ENUMERATED {ms3, ms4, |

| | |
|---|---|
| ms6, ms10, ms20} | OPTIONAL, |

| | |
|---|---|
| musim-GapRepetitionAndOffset-r17 | CHOICE { |

| | |
|---|---|
| ms20-r17 | INTEGER (0..19), |
| ms40-r17 | INTEGER (0..39), |
| ms80-r17 | INTEGER (0..79), |
| ms160-r17 | INTEGER (0..159), |
| ms320-r17 | INTEGER (0..319), |
| ms640-r17 | INTEGER (0..639), |
| ms1280-r17 | INTEGER (0..1279), |
| ms2560-r17 | INTEGER (0..2559), |
| ms5120-r17 | INTEGER (0..5119), |
| ... | |

| | |
|---|---|
| } | OPTIONAL -- Cond periodic |

| | |
|---|---|
| } | |
| MUSIM-Starting-SFN-AndSubframe-r17 ::= | SEQUENCE { |

| | |
|---|---|
| starting-SFN-r17 | INTEGER (0..1023), |

| | |
|---|---|
| startingSubframe-r17 | INTEGER (0..9) |

```
  }
  -- TAG-MUSIM-GAPCONFIG-STOP
  -- ASN1STOP
```

In table 5: musim-AperiodicGap may indicate that the UE is allowed to use the MUSIM aperiodic gap if requested in the UEAssistanceInformation:
musim-GapRepetitionAndOffset may indicate the gap repetition period in ms and gap offset in number of subframes for the periodic MUSIM gap without leaving RRC_CONNECTED state:
musim-Start-SFN-AndSubframe may indicate gap starting position for the aperiodic MUSIM gap without leaving RRC_CONNECTED state. This field is only used for aperiodic gap:
musim-GapToAddModList may be a list of MUSIM periodic gap pattern identities to add or modify without leaving RRC_CONNECTED state: and
musim-GapToReleaseList may be a list of MUSIM periodic gap pattern identities to release without leaving RRC_CONNECTED state.

The musim-GapAssistanceConfig may be a configuration for the UE to report assistance information without leaving RRC_CONNECTED for MUSIM purpose. The musim-GapAssistanceConfig may comprise a musim-GapProhibitTimer, which is a prohibit timer for MUSIM assistance information reporting without leaving RRC_CONNECTED for MUSIM purpose.

The musim-LeaveAssistanceConfig may be a configuration for the UE to report assistance information for leaving RRC_CONNECTED for MUSIM purpose. The musim-LeaveAssistanceConfig may comprise a musim-LeaveWithoutResponseTimer, which indicates the timer for to leave RRC_CONNECTED without network response. When T346g expires, UE autonomously leaves RRC_CONNECTED state and enters RRC_IDLE for MUSIM purpose.

For example, the UE shall perform the following actions upon reception of the RRCReconfiguration, or upon execution of the conditional reconfiguration (CHO, CPA or CPC):
1> if the RRCReconfiguration message includes the musim-GapConfig:
2> for each periodic musim-GapID included in the received musim-GapToReleaseList:
3> release the MUSIM periodic gap associated to the musim-GapID from the musim-GapConfigList:
2> for each periodic musim-GapID included in the received musim-GapToAddModList:
3> if an entry with the matching musim-GapID exists in the musim-GapConfigList:
4> replace the entry with the value received for this musim-GapID:
3> else:
4> add a new entry for this musim-GapID.

For another example, the UE shall:
1> if the received otherConfig includes the musim-GapAssistanceConfig:
2> if musim-GapAssistanceConfig is set to setup:
3> consider itself to be configured to provide MUSIM assistance information without leaving RRC_CONNECTED:
2> else:
3> consider itself not to be configured to provide MUSIM assistance information without leaving RRC_CONNECTED and stop timer T346h, if running:
1> if the received otherConfig includes the musim-LeaveAssistanceConfig:
2> if musim-LeaveAssistanceConfig is set to setup:
3> consider itself to be configured to provide MUSIM assistance information for leaving RRC_CONNECTED in accordance with 5.7.4:
2> else:
3> consider itself not to be configured to provide MUSIM assistance information for leaving RRC_CONNECTED in accordance with 5.7.4 and stop timer T346g, if running.

In step S1103, the UE may perform the UE assistance information procedure in which UE assistance information is transmitted to the network. In the UE assistance information procedure, the UE may inform the network of its preference on the RRC state, its preference to transition out of RRC_CONNECTED state for MUSIM operation, and/or its preference on the MUSIM gaps.

For example, a UE capable of providing assistance information to transition out of RRC_CONNECTED state may initiate the UE assistance information procedure if it was configured to do so, upon determining that it prefers to transition out of RRC_CONNECTED state, or upon change of its preferred RRC state.

For another example, a UE capable of providing MUSIM assistance information may initiate the UE assistance information procedure if it was configured to do so, upon determining that it needs to leave RRC_CONNECTED state, or upon determining it needs the gaps, or upon change of the gap information without leaving RRC_CONNECTED state.

Upon initiating the procedure, the UE shall:
1> if configured to provide its release preference and timer T346f is not running:
2> if the UE determines that it would prefer to transition out of RRC_CONNECTED state: or
2> if the UE is configured with connectedReporting and the UE determines that it would prefer to revert an earlier indication to transition out of RRC_CONNECTED state:
3> start timer T346f with the timer value set to the releasePreferenceProhibitTimer:
3> initiate transmission of the UEAssistanceInformation message to provide the release preference:
1> if configured to provide MUSIM assistance information for leaving RRC_CONNECTED:
2> if the UE needs to leave RRC_CONNECTED state and the timer T346g is not running:
3> initiate transmission of the UEAssistanceInformation message to provide MUSIM assistance information for leaving RRC_CONNECTED:
3> start the timer T346g with the timer value set to the musim-LeaveWithoutResponse Timer:
1> if configured to provide MUSIM assistance information without leaving RRC_CONNECTED:
2> if the UE has a preference on the MUSIM gap(s) and the UE did not transmit a UEAssistanceInformation message with musim-GapPreferenceList since it was configured to provide MUSIM assistance information without leaving RRC_CONNECTED; or
2> if the current musim-GapPreferenceList is different from the one indicated in the last transmission of the UEAssistanceInformation message including musim-GapPreferenceList and the timer T346h is not running:
3> initiate transmission of the UEAssistanceInformation message to provide the current musim-GapPreferenceList:
3> start the timer T346h with the timer value set to the musim-GapProhibitTimer.

The UE shall set the contents of the UEAssistanceInformation message as follows:
1> if transmission of the UEAssistanceInformation message is initiated to provide a release preference:
2> include releasePreference in the UEAssistanceInformation message:
2> set preferredRRC-State to the desired RRC state on transmission of the UEAssistanceInformation message:
1> if transmission of the UEAssistanceInformation message is initiated to provide MUSIM assistance information:
2> if the UE has a preference for MUSIM periodic gap(s):
3> include musim-GapPreferenceList with an entry for each periodic gap the UE prefers to be configured:
4> set musim-Gaplength and musim-GapRepetitionAndOffset in the musim-GapInfo IE to the values of the length and the repetition/offset of the gap(s), respectively, the UE prefers to be configured with:
2> if the UE has a preference for MUSIM aperiodic gap:
3> include the field musim-GapPreferenceList, with one entry for the aperiodic gap the UE prefers to be configured:
4> set musim-Gaplength and musim-Starting-SFN-AndSubframe in the musim-GapInfo IE to the values of respectively the length and the starting SFN/subframe of the gap, respectively, the UE prefers to be configured with:
2> else (if the UE has no longer preference for the periodic/aperiodic gaps):
3> do not include musim-GapPreferenceList in the musim-Assistance IE:
2> if UE has a preference to leave RRC_CONNECTED state:
3> set musim-PreferredRRC-State to the preferred RRC state.

For example, the UE assistance information may comprise preferredRRC-State. The preferredRRC-State may indicate the UE's preferred RRC state. The value idle is indicated if the UE prefers to be released from RRC_CONNECTED and transition to RRC_IDLE. The value inactive is indicated if the UE prefers to be released from RRC_CONNECTED and transition to RRC_INACTIVE. The value connected is indicated if the UE prefers to revert an earlier indication to leave RRC_CONNECTED state. The value outOfConnected is indicated if the UE prefers to be released from RRC_CONNECTED and has no preferred RRC state to transition to. The value connected can only be indicated if the UE is configured with connectedReporting.

For example, the UE assistance information may comprise MUSIM assistance information. The MUSIM assistance information (i.e., MUSIM-Assistance) may comprise at least one of the following information elements as shown in table 6:

TABLE 6

| | |
|---|---|
| MUSIM-Assistance-r17 ::= | SEQUENCE { |
| musim-PreferredRRC-State-r17 | ENUMERATED {idle, inactive, |

| | |
|---|---|
| outOfConnected} | OPTIONAL, |

| | |
|---|---|
| musim-GapPreferenceList-r17 | MUSIM-GapPreferenceList-r17 |
| OPTIONAL, | |
| ... | |
| } | |

MUSIM-GapPreferenceList-r17 ::= SEQUENCE (SIZE (1..3)) OF MUSIM-

| | |
|---|---|
| GapPrefInfo-r17 | |
| MUSIM-GapPrefInfo-r17 ::= | SEQUENCE { -- FFS if reuse IE |
| MUSIM-GapInfo-r17 | |
| musim-Starting-SFN-AndSubframe-r17 | MUSIM-Starting-SFN- |

| | |
|---|---|
| AndSubframe-r17 | OPTIONAL, |

| | |
|---|---|
| musim-GapLength-r17 | ENUMERATED {ms3, ms4, |
| ms6, ms10, ms20}, | |
| musim-GapRepetitionAndOffset-r17 | CHOICE { |
| ms20-r17 | INTEGER (0..19), |
| ms40-r17 | INTEGER (0..39), |
| ms80-r17 | INTEGER (0..79), |
| ms160-r17 | INTEGER (0..159), |
| ms320-r17 | INTEGER (0..319), |
| ms640-r17 | INTEGER (0..639), |
| ms1280-r17 | INTEGER (0..1279), |
| ms2560-r17 | INTEGER (0..2559), |
| ms5120-r17 | INTEGER (0..5119), |
| ... | |

| | |
|---|---|
| } | OPTIONAL |

}

In table 6: musim-GapLength may indicate the length of the UE's preferred MUSIM gap length;
musim-GapOffset may indicate the gap offset of the UE's preferred MUSIM gap;
musim-GapPreferenceList may indicate the MUSIM gap(s) that the UE prefers to be configured with;
musim-PreferredRRC-State may indicate the UE's preferred RRC state when leaving RRC_CONNECTED. The musim-PreferredRRC-State may be identical to the preferredRRC-State. That is, preferredRRC-State may be included in the MUSIM assistance information;
musim-GapRepetitionAndOffsetPeriod may indicate the gap repetition period and gap offset of the UE's preferred periodic MUSIM gap without leaving RRC_CONNECTED state. This field is only used for periodic gaps; and
musim-PrefStarting-SFN-AndSubframex may indicate gap starting position offor UE's preferred aperiodic MUSIM gap without leaving RRC_CONNECTED state.

Hereinafter, paging filtering (or, mobile-terminated (MT) restriction) is described. The described paging filtering may comprise a network based paging filtering, and may be applied to both 5GS (UE in either CM_IDLE or RRC_Inactive state) over 3GPP access and EPS (UE in CM_IDLE state).

The paging filtering/MT restriction may comprise an operation that the network corresponding to USIM_A sends a paging for USIM_A only if paging filtering rules in the network allows to page the UE.

To achieve this, a UE may provide paging filtering information comprising the paging filtering rules in MUSIM assistance information in registration or service request message to the network either over 3GPP access or non-3GPP access. The AMF may only trigger paging over 3GPP access for the MT services allowed by the paging filtering rules when the UE sent leaving indication to the network. The paging filtering rules/paging filtering information may be updated by a further registration or service request message when the UE needs not such filtering, or user settings or preferences change. The paging filtering rules/paging filtering information may be passed to the RAN for the UE in RRC inactive state, and the paging filtering may be based on classification performed at the UPF for user plane e.g. PPI value in the CN tunnel header of the DL PDU. For example, the paging filtering rules/paging filtering information may inform one or more types of paging preferred by the UE. The one or more types of paging may comprise paging related with voice service only, paging related with data only, and/or paging related with disabling SMS. That is, the paging filtering rules/paging filtering information may indicate that the UE wants to receive/the UE request the network to transmit/the network is allowed to transmit paging related with voice service only, or data only, or disable SMS.

The paging filtering rules in the MUSIM assistance information in the registration request may also block entirely the paging. If so, the paging filtering rules/paging filtering information sent to the network may filter all services as not eligible for paging.

The paging filtering rules can be based on user settings, e.g., the user can make a configuration for which services are to be subject to paging per USIM. The user settings and preferences can also be triggered when certain applications are started in a MUSIM device, to make the behaviour dynamic and not just based on static configuration.

The AMF may provide the paging filtering rules to the RAN so that the RAN can decide whether to send paging to the UE of user plane services when the UE is in RRC inactive state (the paging for control plane services is controlled at the AMF at all times). The service causing the paging may be determined by the AMF or RAN by reusing the mechanism of PPD feature.

In the case of CM-IDLE state, the UPF may send the DSCP in TOS of IP header towards the SMF and the SMF will determine whether to send notification to AMF. If so, the SMF may include the PPI, the ARP and the 5QI of the corresponding QoS Flow. The AMF may determine which service caused paging based on the PPI, ARP and 5QI.

In the case of RRC-Inactive state, the UPF may add the PPI value in CN tunnel header of a DL PDU and RAN may determine which service caused paging based on the PPI, ARP and 5QI.

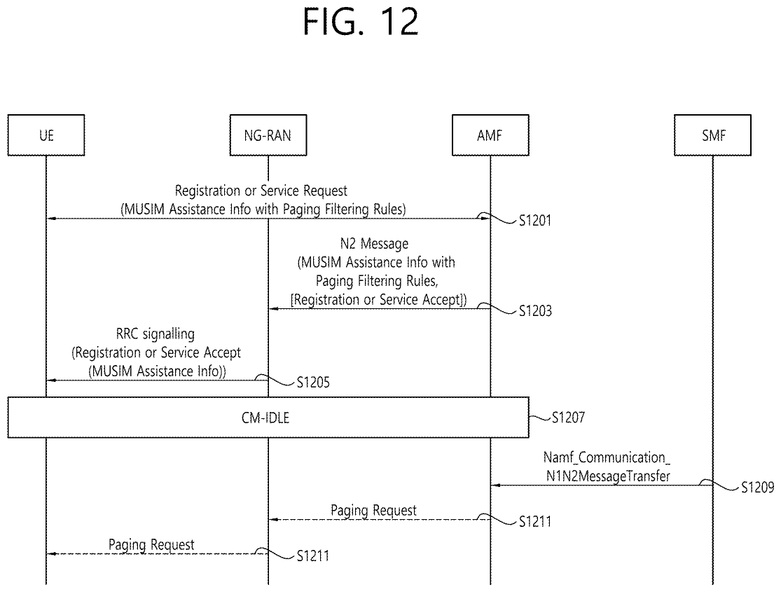

FIG. 12 shows an example of a paging filtering based paging delivery in CM-IDLE state in 5GS according to an embodiment of the present disclosure. Initially, the UE can be in CM-CONNECTED or CM-IDLE or CM-CONNECTED with RRC Inactive state.

Referring to FIG. 12, in step S1201, the UE may send registration or service request message with MUSIM assistance information with paging filtering rules over 3GPP access or non-3GPP access, which indicates list of services the UE wants to be notified. The UE may request to update the existing paging filtering rules by sending registration request procedure. The UE can send service request message with paging filtering rules and leave indication at the same time.

In step S1203, the AMF may store the MUSIM assistance information with paging filtering rules and send registration or service accept message to the UE. The AMF may send the MUSIM Assistance Information with Paging Filtering Rules to the NG-RAN and the NG-RAN may store the Paging Filtering Rules. The MUSIM Assistance Information sent to the NG-RAN may include only user plane services rules. The AMF may update the RAN with fresh MUSIM Assistance Information with Paging Filtering Rules whenever they change compared to the ones stored at the AMF. The Paging Filtering Rules may lift any paging filtering or stop completely paging also, as an option. The registration accept message may contain information (e.g. by network capability or including MUSIM assistance information) whether the network supports MUSIM. The Paging Filtering Rules sent to the NG-RAN may be used when a UE is in RRC-Inactive.

In step S1205, the NG-RAN may forward to the UE the Registration Accept.

In step S1207, the UE may be in CM-IDLE state over 3GPP access.

In step S1209, The SMF may trigger Namf_Communication_NIN2MessageTransfer to activate user plane and include ARP, PPI and 5QI.

In step S1211, based on the ARP, PPI and 5QI, the AMF may determine which service caused paging and decide whether to send paging considering the paging filtering rules received in step S1201. UE may decide with what frequency and under what circumstances it sends paging filtering rules. The network can either accept or reject the request. It is expected the UE would not change the rules very frequently.

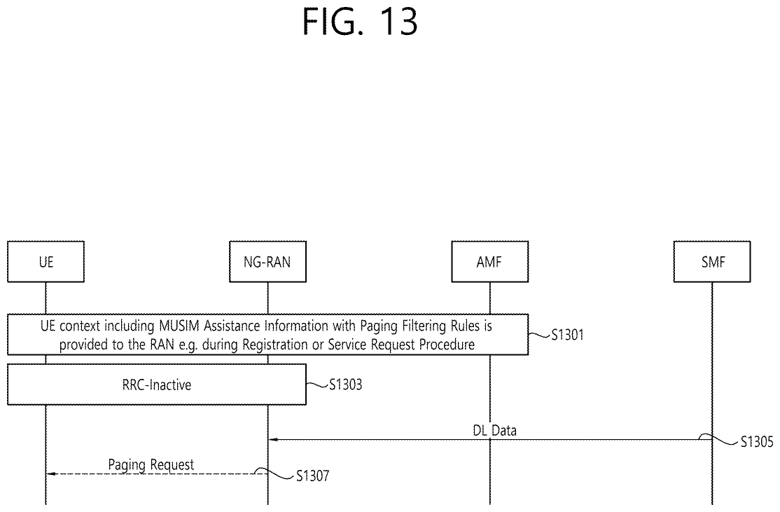

FIG. 13 shows an example of a prioritized service list based paging delivery in RRC-inactive state in 5GS according to an embodiment of the present disclosure. Initially, the UE can be in CM-CONNECTED or CM-IDLE or CM-CONNECTED with RRC Inactive state.

Referring to FIG. 13, in step S1301, the UE context including MUSIM Assistance

Information with Paging Filtering Rules may be provided to the RAN after the UE performs Registration Request procedure as described in steps S1201 to S1205 in FIG. 12.

In step S1303, the UE is in RRC_inactive state.

In step S1305, the UPF may send DL PDU to the NG-RAN including PPI value in the CN tunnel header of the DL PDU.

In step S1307, based on the ARP, PPI and 5QI, the NG-RAN may determine which service caused paging and decide whether to send paging considering the MUSIM Assistance Information with Paging Filtering Rules received in step S1301.

For paging delivery in EPS, the same mechanism in CM-IDLE state in 5GS as illustrated in FIG. 12 may also apply to EPS.

Meanwhile, a Multi-USIM device (i.e. MUSIM UE) may have concurrent registrations associated with several USIMs. While actively communicating with the system associated with one USIM (e.g., current system and/or first system), the MUSIM UE may determine that it needs to perform some activity (e.g. respond to a page, or perform mobility update) in the other system associated with other USIM(s) (e.g., the second system(s)).

To support activities in the other system associated with other USIM, a scheduling gap function may be used. The scheduling gap may comprise a duration that is configured/allowed by the current system i.e. the first system. During the duration configured for the scheduling gap, the UE may pause (e.g., suspend) the existing RRC connection on the current system and perform RRC procedures (e.g., RRC establishment procedure/RRC connection establishment procedure) in the other system.

As another way, if the UE doesn't need to be configured or cannot support the scheduling gap function, the UE may need to receive RRC connection release from the network before leaving the current system (i.e., before releasing/suspending a connection with the current system or before entering an inactive/idle state for the current system). In one of these procedures, the UE may send UE assistance information (which is RRC message) including the preferred RRC state set by RRC_INACTIVE to the network. Then, the network may send an RRC connection release message including the suspend configuration to transfer the UE into RRC_INACTIVE state.

However, there may be the case when NAS assistance information for indicating paging filtering (i.e., MT restriction) is needed. For paging filtering, the UE may provide the Paging Filtering Rules in the MUSIM Assistance Information (which is NAS message and/or NAS assistance information) in Registration or Service Request message to the network either over 3GPP access or non-3GPP access. The AMF may only trigger paging over 3GPP access for the MT services allowed by the Paging Filtering Rules when the UE sent leaving indication to the network.

For example, in the case of leaving procedure that the UE sends the UE assistance information including preferred RRC state set by RRC_INACTIVE to the network, the UE cannot send NAS assistance information for indicating paging filtering because the UE may have already received an RRC connection release message including suspend configuration from the network as a response for the UE assistance information and enter an inactive state before sending the NAS assistance information for indicating paging filtering. Therefore, the UE needs to send together both of the UE assistance information for preferred RRC state and NAS assistance information for paging filtering before leaving. As vice versa, in the case of leaving procedure that the UE sends the NAS assistance information for paging filtering to the network, the UE may not be able to send the UE assistance information for the RRC state preference.

According to implementations of the present disclosure, while performing Multi-USIM operation, to send both the UE assistance information for indicating preferred RRC state and NAS assistance information for indicating paging filtering information (e.g., paging filtering rules), the UE may send, to the first network on SIM A, an RRC message, e.g. UEAssistanceInformation including preferred RRC state and new indication. The new indication may indicate that the preferred RRC state is for MUSIM operation on the other SIM and/or paging filtering information is to be transmitted. After reception of the new indication, the network may prepare an RRC message (i.e., RRC release message) to release/suspend the current RRC connection including configuration to transfer the UE into the preferred RRC state, and may wait for receiving NAS signalling to release the current service. In the meantime, the UE may send NAS assistance information for paging filtering and ongoing service release. After the reception of the NAS assistance information, the network may send the prepared RRC message to release/suspend the current RRC connection including configuration to transfer the UE into the preferred RRC state.

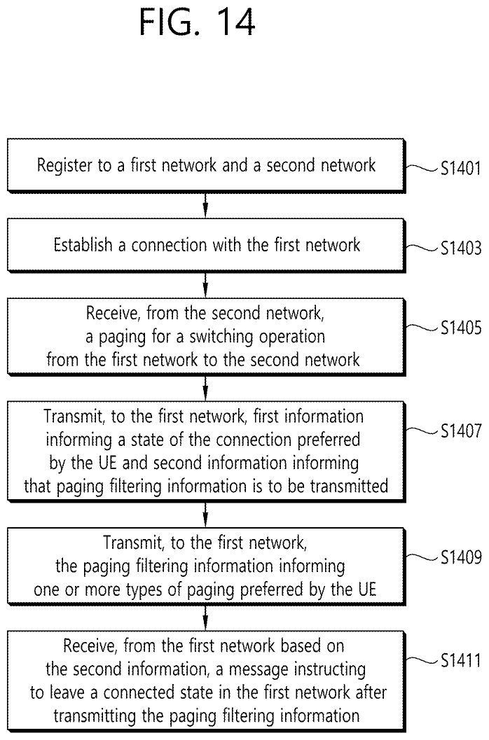

FIG. 14 shows an example of a method performed by a UE according to an embodiment of the present disclosure. The method may also be performed by a wireless device.

Referring to FIG. 14, in step S1401, the UE may register to a first network and a second network.

In step S1403, the UE may establish a connection with the first network. Upon establishing the connection with the first network, the UE may enter a connected state in the first network.

In step S1405, the UE may transmit, to the first network, first information (e.g., preferredRRC-State and/or musim-PreferredRRC-State) informing a state of the connection preferred by the UE and second information informing that paging filtering information (e.g., paging filtering rules) is to be transmitted.

In step S1407, the UE may transmit, to the first network, the paging filtering information informing one or more types of paging preferred by the UE.

In step S1409, the UE may receive, from the first network based on the second information, a message instructing to leave a connected state in the first network after transmitting the paging filtering information.

According to various embodiments, the first information may inform an intend of the UE to leave a connected state in the first network and the state of the connection preferred by the UE in the first network after the leaving.

According to various embodiments, the switching operation comprises at least one of: releasing or suspending the connection with the first network: establishing a connection with the second network: or receiving data from the second network.

According to various embodiments, the state of the connection preferred by the UE may comprise a radio resource control (RRC) state preferred by the UE in the first network when the UE leaves a connected state in the first network. The RRC state preferred by the UE may comprise at least one of an inactive state or an idle state.

According to various embodiments, the message instructing to leave the connected state in the first network may instruct the UE to enter a non-connected state which is identical to the RRC state preferred by the UE or different from the RRC state preferred by the UE.

According to various embodiments, the non-connected state may comprise the inactive state. The message instructing to leave the connected state in the first network may comprise an RRC release message including a suspend configuration.

According to various embodiments, the first information and the second information may be transmitted to the first network via a radio resource control (RRC) signalling. The paging filtering information may be transmitted to the first network via a non-access stratum (NAS) signalling.

According to various embodiments, the RRC signalling may comprise UE assistance information. The UE assistance information or multi-user subscriber identity module (MUSIM) assistance information in the UE assistance information may comprise at least one of the first information or the second information.

According to various embodiments, the first information may inform an intend of the UE to leave a connected state in the first network and the state of the connection preferred by the UE in the first network after the leaving.

According to various embodiments, the NAS signalling or NAS assistance information in the NAS signalling comprises at least one of the paging filtering information or an indication to release an on-going service in the first network.

According to various embodiments, the one or more types of paging may comprise at least one of: a paging related with only a voice service: a paging related with only a data service; a paging for disabling a short-messaging service (SMS); or a paging for resuming the connection with the first network.

According to various embodiments, the UE may register to both a first network and a second network. The UE may receive a paging message from the second network. The UE may send an information to the first network to indicate a preference of the UE AS to transfer to RRC_INACTIVE state for switching operation from the first network to the second network. The UE may send a request to release the ongoing service of the UE NAS to the first network upon/after sending the information to indicate the preference of the UE AS. The UE may receive a message to release/suspend the RRC connection on the first network. The message may indicate that the UE AS is allowed to transfer to RRC_INACTIVE state.

Furthermore, the method in perspective of the UE described above in FIG. 14 may be performed by first wireless device 100 shown in FIG. 2, the wireless device 100 shown in FIG. 3, the first wireless device 100 shown in FIG. 4 and/or the UE 100 shown in FIG. 5.

More specifically, the UE comprises at least one transceiver, at least processor, and at least one computer memory operably connectable to the at least one processor and storing instructions that, based on being executed by the at least one processor, perform operations.

The operations comprise: registering to a first network and a second network; establishing a connection with the first network; receiving, from the second network, a paging for a switching operation from the first network to the second network; transmitting, to the first network, first information informing a state of the connection preferred by the UE and second information informing that paging filtering information is to be transmitted: transmitting, to the first network, the paging filtering information informing one or more types of paging preferred by the UE; and receiving, from the first network based on the second information, a message instructing to leave a connected state in the first network after transmitting the paging filtering information.

Furthermore, the method in perspective of the UE described above in FIG. 14 may be performed by a software code 105 stored in the memory 104 included in the first wireless device 100 shown in FIG. 4.

More specifically, at least one computer readable medium (CRM) stores instructions that, based on being executed by at least one processor, perform operations comprising: registering to a first network and a second network: establishing a connection with the first network: receiving, from the second network, a paging for a switching operation from the first network to the second network: transmitting, to the first network, first information informing a state of the connection preferred by the UE and second information informing that paging filtering information is to be transmitted; transmitting, to the first network, the paging filtering information informing one or more types of paging preferred by the UE: and receiving, from the first network based on the second information, a message instructing to leave a connected state in the first network after transmitting the paging filtering information.

Furthermore, the method in perspective of the UE described above in FIG. 14 may be performed by control of the processor 102 included in the first wireless device 100 shown in FIG. 2, by control of the communication unit 110 and/or the control unit 120 included in the wireless device 100 shown in FIG. 3, by control of the processor 102 included in the first wireless device 100 shown in FIG. 4 and/or by control of the processor 102 included in the UE 100 shown in FIG. 5.

More specifically, an apparatus configured to operate in a wireless communication system (e.g., wireless device/UE) comprises at least processor, and at least one computer memory operably connectable to the at least one processor. The at least one processor is configured to perform operations comprising: registering to a first network and a second network: establishing a connection with the first network; receiving, from the second network, a paging for a switching operation from the first network to the second network: transmitting, to the first network, first information informing a state of the connection preferred by the UE and second information informing that paging filtering information is to be transmitted; transmitting, to the first network, the paging filtering information informing one or more types of paging preferred by the UE: and receiving, from the first network based on the second information, a message instructing to leave a connected state in the first network after transmitting the paging filtering information.

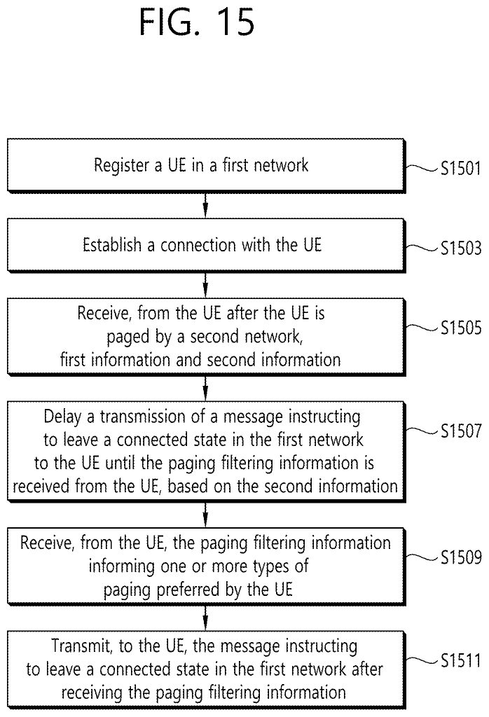

FIG. 15 shows an example of a method performed by a network node according to an embodiment of the present disclosure. The network node may comprise a base station (BS).

Referring to FIG. 15, in step S1501, the network node may register a user equipment (UE) in a first network.

In step S1503, the network node may establish a connection with the UE.

In step S1505, the network node may receive, from the UE after the UE is paged by a second network, i) first information informing an intend of the UE to leave a connected state in the first network and a state in the first network preferred by the UE after the leaving, and ii) second information informing that paging filtering information is to be transmitted.

In step S1507, the network node may delay a transmission of a message instructing to leave a connected state in the first network to the UE until the paging filtering information is received from the UE, based on the second information.

In step S1509, the network node may receive, from the UE, the paging filtering information informing one or more types of paging preferred by the UE.

In step S1511, the network node may transmit, to the UE, the message instructing to leave a connected state in the first network after receiving the paging filtering information.

Furthermore, the method in perspective of the network node described above may be performed by second wireless device 100 shown in FIG. 2, the device 100 shown in FIG. 3, and/or the second wireless device 200 shown in FIG. 4.

More specifically, the network node comprises at least one transceiver, at least processor, and at least one computer memory operably connectable to the at least one processor and storing instructions that, based on being executed by the at least one processor, perform operations.

The operations comprise: registering a user equipment (UE) in a first network; establishing a connection with the UE: receiving, from the UE after the UE is paged by a second network, i) first information informing an intend of the UE to leave a connected state in the first network and a state in the first network preferred by the UE after the leaving, and ii) second information informing that paging filtering information is to be transmitted: delaying a transmission of a message instructing to leave a connected state in the first network to the UE until the paging filtering information is received from the UE, based on the second information; receiving, from the UE, the paging filtering information informing one or more types of paging preferred by the UE; and transmitting, to the UE, the message instructing to leave a connected state in the first network after receiving the paging filtering information.

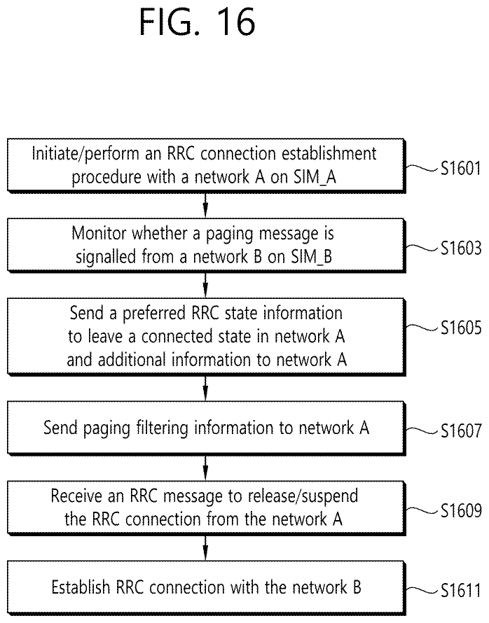

FIG. 16 shows an example of a method for sending RRC preference for MT restriction in MUSIM according to an embodiment of the present disclosure. The method may be performed by a UE and/or a wireless device.

Referring to FIG. 16, in step S1601, the UE may initiate/perform an RRC connection establishment procedure with a network on SIM_A (i.e., network A). Then, the UE may enter a connected mode in the network A for the SIM_A. The UE may be in a non-connected mode (e.g., inactive mode or idle mode) in a network B for SIM_B. The UE may be capable to support multiple-USIM operations, i.e. MUSIM operation. The UE may initiate the RRC connection establishment procedure to a network on SIM_A (i.e., network A).

In step S1603, the UE may monitor whether a paging message is signalled from a network on SIM_B (i.e., network B). The UE may be in a non-connected mode in the network B for SIM_B.

The UE may use gap configuration (e.g., scheduling gap) to monitor paging messages on the network B. The gap configuration may be provided by the network A according to the UE request. During the period of the gap, the UE may perform at least one of the followings:
The UE may monitor paging information from network B. While monitoring paging information on the network B, the UE may receive a paging message from the network B:
The UE may perform measurements on network B based on the measurement information/configuration received from the network B;
The UE may perform idle mode mobility such as cell selection/reselection in network B;
The UE may receive system information in network B;
The UE may perform NAS signalling with network B:
The UE may perform RRC connection establishment with network B: or
The UE may send or receive data in network B.

In step S1605, the UE may send a preferred RRC state information (e.g., preferredRRC-State and/or musim-PreferredRRC-State) to network A to release/suspend the RRC connection or leave a connected state in the network A. The UE may be in a connected mode in network A for SIM_A, and non-connected mode in network B for SIM_B.

To perform necessary operations in network B, the UE may transmit an RRC message, e.g. UEAssistanceInformation including the preference of the RRC state information to the network A. In addition to the preference of the RRC state, the UE may send additional information to send NAS assistance information for paging filtering. The additional information may indicate that the preference of the RRC state, e.g., RRC_INACTIVE or RRC_IDLE is for leaving the network A to handle the paging message from the network B. Also, the additional information implicitly indicate that the UE will request the service release via NAS signalling and may include the NAS assistance information to indicate paging filtering information. That is, the additional information may inform that the paging filtering information is to be transmitted. The additional information and/or the preference of the RRC state may be set by single bit information in the RRC message.

From a network operation perspective, after reception of the additional information, the network A may prepare an RRC message to release/suspend the RRC connection (i.e., RRC release message) including a suspend configuration to transfer the UE into the RRC_INACTIVE state. However, the network A may not send the RRC message promptly/immediately due to the additional information. For example, the network A may wait until the NAS assistance information for paging filtering (i.e., paging filtering information/paging filtering rules) is received from the UE based on the additional information, and after receiving the NAS assistance information for paging filtering from the UE, the network A may transmit the RRAC message to release/suspend the RRC connection to the UE.

In step S1607, the UE may send paging filtering information to network A before releasing/suspending the RRC connection with the network A. Before releasing/suspending the RRC connection with the network A, the UE may be in a connected mode in the network A for SIM_A, and non-connected mode in the network B for the SIM_B.

Upon/after sending the RRC message, e.g. UEAssistanceInformation including the preference of the RRC state information to the network A, the UE AS, e.g. RRC layer may indicate to UE NAS that UE AS will release/suspend the RRC connection. Then, the UE NAS may send the NAS assistance information including paging filtering information together with a release indication of ongoing service in the network A.

From a network operation perspective, after the reception of the NAS assistance information, the network A may create a rule to send paging messages for the UE according to the received paging filtering information, and may send RRC message, e.g. RRCRelease to release/suspend the RRC connection on the network A. In the RRC message, suspend configuration may be included for transferring the UE to RRC_INACTIVE state.

In step S1609, the UE may receive an RRC message to release/suspend the RRC connection from the network A. Before receiving the RRC message, the UE may be in a connected mode for the network A on SIM_A, and non-connected mode for the network B on SIM_B.

After sending the paging filtering information to network A, the UE may receive an RRC message, e.g. RRCRelease including the suspend configuration. Then, the UE may enter RRC_INACTIVE state on the network A according to the suspend configuration.

In step S1611, the UE may establish RRC connection with the network B. Now the UE is in a non-connected mode (e.g., inactive mode) for network A on SIM_A, and connected mode for network B on SIM_B.

After entering RRC_INACTIVE state on the network A, the UE may send a request (e.g., RRC setup request) to the network B to establish an RRC connection with the network B for handling paging messages.

The present disclosure can have various advantageous effects.

For example, the UE can send the RRC state preference for entering RRC_INACTIVE and MT restriction for paging filtering. As the result, the network can transfer the UE into RRC_INACTIVE state and can send the filtered paging messages to the UE in RRC_INACTIVE. Upon reception of the filtered paging message, the UE can perform an RRC connection resume procedure which can achieve faster data transmission than RRC connection establishment.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a user equipment (UE) in a wireless communication system, the method comprising:
registering to a first network and a second network;
establishing a connection with the first network;
receiving, from the second network, a paging for a switching operation from the first network to the second network;
transmitting, to the first network, first information informing a state of the connection preferred by the UE and second information informing that paging filtering information is to be transmitted;
transmitting, to the first network, the paging filtering information informing one or more types of paging preferred by the UE; and
receiving, from the first network based on the second information, a message instructing to leave a connected state in the first network after transmitting the paging filtering information.

2. The method of claim 1, wherein the switching operation comprises at least one of:
releasing or suspending the connection with the first network;
establishing a connection with the second network; or
receiving data from the second network.

3. The method of claim 1, wherein the state of the connection preferred by the UE comprises a radio resource control (RRC) state preferred by the UE in the first network when the UE leaves a connected state in the first network, and
wherein the RRC state preferred by the UE comprises at least one of an inactive state or an idle state.

4. The method of claim 3, wherein the message instructing to leave the connected state in the first network instructs the UE to enter a non-connected state which is identical to the RRC state preferred by the UE or different from the RRC state preferred by the UE.

5. The method of claim 4, wherein the non-connected state comprises the inactive state, and
wherein the message instructing to leave the connected state in the first network comprises an RRC release message including a suspend configuration.

6. The method of claim 1, wherein the first information and the second information are transmitted to the first network via a radio resource control (RRC) signalling, and
wherein the paging filtering information is transmitted to the first network via a non-access stratum (NAS) signalling.

7. The method of claim 6, wherein the RRC signalling comprises UE assistance information,
wherein the UE assistance information or multi-user subscriber identity module (MUSIM) assistance information in the UE assistance information comprises at least one of the first information or the second information, and
wherein the first information informs an intend of the UE to leave a connected state in the first network and the state of the connection preferred by the UE in the first network after the leaving.

8. The method of claim 6, wherein the NAS signalling or NAS assistance information in the NAS signalling comprises at least one of the paging filtering information or an indication to release an on-going service in the first network.

9. The method of claim 1, wherein the one or more types of paging comprises at least one of:
a paging related with only a voice service;
a paging related with only a data service;
a paging for disabling a short-messaging service (SMS); or
a paging for resuming the connection with the first network.

10. The method of claim 1, wherein the UE is in communication with at least one of a mobile device, a network, or autonomous vehicles other than the UE.

11. A user equipment (UE) configured to operate in a wireless communication system, the UE comprising:
at least one transceiver;
at least processor; and
at least one computer memory operably connectable to the at least one processor and storing instructions that, based on being executed by the at least one processor, perform operations comprising:
registering to a first network and a second network;
establishing a connection with the first network;
receiving, from the second network, a paging for a switching operation from the first network to the second network;
transmitting, to the first network, first information informing a state of the connection preferred by the UE and second information informing that paging filtering information is to be transmitted;
transmitting, to the first network, the paging filtering information informing one or more types of paging preferred by the UE; and
receiving, from the first network based on the second information, a message instructing to leave a connected state in the first network after transmitting the paging filtering information.

12. The UE of claim 11, wherein the first information and the second information are transmitted to the first network via a radio resource control (RRC) signalling, and
wherein the paging filtering information is transmitted to the first network via a non-access stratum (NAS) signalling.

13. The UE of claim 12, wherein the RRC signalling comprises UE assistance information,
wherein the UE assistance information or multi-user subscriber identity module (MUSIM) assistance information in the UE assistance information comprises at least one of the first information or the second information, and
wherein the first information informs an intend of the UE to leave a connected state in the first network and the state of the connection preferred by the UE in the first network after the leaving.

14. The UE of claim 12, wherein the NAS signalling or NAS assistance information in the NAS signalling comprises at least one of the paging filtering information or an indication to release an on-going service in the first network.

15-17. (canceled)

18. A network node configured to operate in a wireless communication system, the network node comprising:
at least one transceiver;
at least processor; and
at least one computer memory operably connectable to the at least one processor and storing instructions that, based on being executed by the at least one processor, perform operations comprising:
registering a user equipment (UE) in a first network;
establishing a connection with the UE;
receiving, from the UE after the UE is paged by a second network, i) first information informing an intend of the UE to leave a connected state in the first network and a state in the first network preferred by the UE after the leaving, and ii) second information informing that paging filtering information is to be transmitted;
delaying a transmission of a message instructing to leave a connected state in the first network to the UE until the paging filtering information is received from the UE, based on the second information;
receiving, from the UE, the paging filtering information informing one or more types of paging preferred by the UE; and
transmitting, to the UE, the message instructing to leave a connected state in the first network after receiving the paging filtering information.
